(19) United States
(12) Patent Application Publication
(10) Pub. No.: US 2014/0278428 A1
(43) Pub. Date: Sep. 18, 2014

(54) TRACKING SPOKEN LANGUAGE USING A DYNAMIC ACTIVE VOCABULARY

(71) Applicant: Coho Software LLC, Bozeman, MT (US)

(72) Inventor: Steve Rolland, Bozeman, MT (US)

(73) Assignee: Coho Software LLC, Bozeman, MT (US)

(21) Appl. No.: 14/213,440

(22) Filed: Mar. 14, 2014

Related U.S. Application Data
(60) Provisional application No. 61/787,297, filed on Mar. 15, 2013.

(51) Int. Cl. G10L 21/10

(52) U.S. Cl. CPC G10L 21/10
USPC 704/257

(57) ABSTRACT

Systems and methods to provide a set of dictionaries and highlighting lists for speech recognition and highlighting, where the speech recognition focuses only on a limited scope of vocabulary as present in a document. The systems and methods allow a rapid and accurate matching of the utterance with the available text, and appropriately indicate the location in the text or signal any errors made during reading. Described herein is a system and method to create speech recognition systems focused on reading a fixed text and providing feedback on what they read to improve literacy, aid those with disabilities, and to make the reading experience more efficient and fun.

### CROSS-REFERENCE TO RELATED APPLICATIONS

This application claims priority to U.S. Provisional Patent Application Ser. No. 61/787,297, filed on Mar. 15, 2013 to Steve Rolland entitled “Tracking Spoken Language Using a Dynamic Active Vocabulary”, currently pending, the entire disclosure of which is incorporated herein by reference.

### FIELD

This disclosure relates generally to systems and methods for interpreting spoken language, more particularly, to provide an instantaneous indication of printed text that has been read aloud.

### BACKGROUND

Speech recognition systems are well known. Traditionally these systems have been used to record and interpret spoken language for generating commands for computer and phone systems, among other similar instances, as well as to act as an automated process of dictation. Many systems and approaches are well known, and several companies have been created to provide speech recognition, notably Nuance Communications, as well as several public, open-source options.

As proven by Nuance Communications, there exists enough commercial interest to invest in speech recognition technology and approaches, and this is a difficult problem to solve effectively. Spoken language recognition is sensitive to vocabulary usage, speaker diction, rate, accent, tone, and numerous other variations. To accurately interpret the spoken word requires interpreting the auditory impulses, transforming the impulses into phoneme or word segments, then matching those phonemes or words against a vocabulary and attempting to identify the correct word to match the vocal utterance. This process requires immense skill and understanding of numerous fields of discipline.

Nuance Communications and others have made available products and tool sets to allow others to adapt these techniques to various applications. Unfortunately, due to the complexity of the underlying technology, the tools and products have limited configurability and thus seen limited application domains. As noted, these domains have focused on tasks such as word processing or similar transcription approaches for other applications, telephone interactive voice response (IVR) command systems, and embedded command systems for robotics, search engines, and other similar areas.

The available systems separate their functionality into two configurable areas, the language model and the vocabulary or dictionary. The language model includes such things as accent recognition and similar utterance interpretation techniques. The vocabulary or dictionary defines the range of utterances that are recognized.

Each of the existing applications of voice recognition uses the underlying speech recognition technology in one of two ways: (1) free form, unlimited vocabulary recognition, or (2) limited vocabulary recognition based upon a specific set of commands or restricted language scope. The first method is used for applications like word processing, general transcription, entering information into mobile phones, and the like. The second technique is used for recognizing command languages for search engines, IVR systems, robotic control, and similar areas.

The first approach requires the use of a large language dictionary to match against spoken utterances, and the focus of the technology in this area is the efficient matching of an utterance against the large potential vocabulary Importantly, no matter how efficient the processing technique or speed of the computational hardware, comparing an utterance against a large set of potential utterances takes time. As experienced in the existing available products, this time is noticeable to the user in many different manifestations. Commonly the applications attempt to hide this delay whenever possible, but for certain applications this delay is unavoidably noticeable. In addition, with a large vocabulary comes an increased error rate for matching the utterance. For example, a slight slurring of an utterance or even a mispronunciation could drastically change the identified word to be distinct from the intended word.

The second approach requires the pre-specification of a limited vocabulary to recognize. This approach is used where it is not essential to allow a completely free-form interaction and where recognition must either be highly accurate or where delays in recognition are unacceptable. As experienced in the existing available products, these approaches are less sensitive to accents and mispronunciations and also have less noticeable delays in recognition.

What is missing from the available speech recognition techniques is an approach that works on a very large vocabulary to instantly and accurately recognize even potentially misspoken words. While this is the underlying goal of all speech recognition, for the reasons noted above there are technical limitations to doing this in all scenarios. However, since the general problem has been the focus of the prior work in the area, specific applications such as comparing spoken utterances against a fixed text (e.g. a book) have been overlooked. Thus, no current systems in the art focus on instantaneously matching spoken utterances against a specific text as one reads the text out loud, in spite of vast commercial opportunity across several domains.

### BRIEF DESCRIPTION OF THE DRAWINGS

FIG. 1 is a block diagram of an example embodiment of a figure upon which embodiment's inventive subject matter can execute.

FIG. 2 is a flowchart of one particular method for performing actions in accordance with eReader interactions according to embodiments.

FIG. 3 is a block diagram of a set of components necessary for an active dictionary according to embodiments.

FIG. 4 is a block diagram of a set of components necessary for highlighting according to embodiments.

### DETAILED DESCRIPTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims The following detailed description is, therefore, not to be taken in a limiting sense, and the scope of the inventive subject matter is defined only by the appended claims.

For illustrative purposes, various embodiments may be discussed below with reference to an electronic reader (eReader). The most common example discussed in detail is for the reading of a story to a child. This is only one example of a suitable environment and is not intended to suggest any limitation as to the scope of use or functionality of the inventive subject matter. Neither should it be interpreted as having any dependency or requirement relating to any one or a combination of components illustrated in the example operating environments described herein.

In general, various embodiments combine, in an eReader, the opportunity to instantaneously highlight words or portions of words as they are spoken. Thus some embodiments aid those new to reading, learning the language of the text, aiding those with disabilities, displaying a teleprompter, providing a graphically enhanced reading experience, or even using a physical (i.e. printed) book overlay.

In the specifics of discussing speech recognition and visual interaction, several definitions will be used in the specification. First, “eReader” is any process relating to the electronic display of textual information. Specifically, the eReader must include or have the capacity to interact with a microphone, voice recordings, or other voice input device to register the reader's utterance, and may be part of a computer system, a purpose built item, or even an overlay system for traditional printed material. “Utterances” can be taken to mean either a complete spoken word or individual phonemes within a word, word fragments, or identifiable non-words (e.g. toddler language “mama” for “mom”). The eReader includes multiple distinct “highlighting” methods to identify and track the spoken utterance. These highlighting methods may include providing a visual indicator for the word currently being spoken, the current phoneme (sub-portion of a word) currently being spoken, a mis-spoken or mispronounced word or phoneme, or previously spoken words or phonemes. Each highlightable item may receive the same or different visual indicators to distinguish the various characteristics. For example, a word being spoken may visually indicate each phoneme with a light yellow color and a full word with a dark yellow. Previously spoken words may be lightly crossed out, and mispronounced words or phonemes may be indicated with flashing. Obviously the highlighting can occur via foreground or background color, crossing out or removing words, changing word size, blinking the word or otherwise animating it, or any number of indicators.

Each step in the herein described speech recognition and highlighting system includes the description of the necessary components of the dictionary and language model necessary to address the construction of a dynamic active vocabulary system for tracking spoken utterances and highlighting the relevant part of a text document. The dictionary and language models may be discussed separately when the interaction between them may occur in any combination. If a specific interaction between the dictionary and language model are required, those interactions will be explicitly mentioned for certain embodiments.

Dictionary

The relevant dictionary for the disclosed embodiments begins with the text of the document in the eReader. This text could range from a few words in total (e.g. in the case of a simple children's book) to a very large vocabulary of words used in a lengthy tome or even scientific textbook. The dictionary is loaded and processed, in some embodiments, upon loading and parsing the electronic text in the eReader. In alternative embodiments the dictionary could be pre-constructed and part of each text, available as a library of dictionaries for a corresponding library of texts, processed “on-the-fly” as the text is being read, or any number of other initialization approaches. As the dictionary is representative only of the text in the document, if that text happens to be English, Spanish, or any other language, the dictionary simply accepts the vocabulary as written in the text. Thus, the dictionary may contain multiple languages within its structure if the text happens to use multiple languages. Similarly, the type of text encoding (e.g. html, rich text, EPUB, PDF, etc.) is irrelevant for this type of approach as, at most, an additional processing step needs to be carried out to interpret the text into a dictionary format. Also, this approach applies to any length of document, from a book with a single word, to one with one word per page, to short stories, to novels or textbooks. As the dictionary is constructed from the text, the text may be written at any reading level or complexity, including domains with specialized language such as science or the law.

Next, the dictionary scope is limited to the nearby textual context. Thus, while the text of the eReader may consist of hundreds of pages and the dictionary contains thousands of words, the scope of the dictionary for processing is limited only to the next few words in the text rather than any word that appears within the text or dictionary or the language at large. The active vocabulary for processing is therefore limited to only a small handful of words immediately after the last word uttered, allowing for a faster recognition of the spoken utterance, as well as a more accurate recognition of the utterance. Importantly, this limited scope also allows for fast and accurate recognition even on eReader devices with very slow processing speed. For example, if the eReader contained the entire text of this patent, when a reader begins reading this paragraph the active dictionary may contain only the three words, “dictionary, next, the” and, in some embodiments, not even the rest of the first sentence or the end of the preceding paragraph or sentence. In other embodiments the scope of the context may be larger and include whole sentences, preceding words or sentences, or other larger but still limited scopes. Using only this limited vocabulary for matching against an utterance, the system is able to quickly identify if utterance is one of the available words, potentially even at the phoneme level. Poor pronunciation, unusual speaking patterns or accents or similar issues which prove problematic for a speech recognition system to identify words from a larger dictionary are avoided when the scope of potential matches is limited to only a handful of words. Notably, this allows the system to recognize if words are skipped, mispronounced, or other common errors for certain user groups which could then be used to provide feedback on these errors.

Language Models

As discussed earlier, speech recognition systems consist of both a dictionary and a language model. The language model incorporates the manner of speech, such as accents. In certain embodiments the dictionary may trigger the use of a specific language model. For instance, if Spanish words appear in the dictionary, the system may use a Spanish language model. If both Spanish and English words appear in the dictionary, the system may use a language model with recognition of Spanish accents for English speakers. In addition, since the dictionary is focused on a smaller active vocabulary, in certain embodiments multiple related language models could be used, for example, both an English language model and an English language with Spanish accents language model.

With the combination of a smaller active vocabulary and a language model that is focused on the text, this system is able to quickly identify pronunciation errors that would otherwise match incorrect words in a traditional approach. The granularity of recognizable error is much greater with this focused approach, allowing recognition at the phoneme level. This is an important function for certain embodiments to help new language learners, to help those adjust their accents to a locale, or even to help those with various disabilities receive another type of feedback to overcome their disability.

In certain embodiments the language model could even be specific to a particular representative model for a population, whether deaf or otherwise disabled, or even for beginning readers who use a “toddler” language. Within the population of toddlers, specific speech pathologies are predictive. For example, toddlers may speak “tat” for cat, “doe” for go, “pish” for fish, “tootie” for cookie, “dump” for jump, “two” for shoe, or “twee” for three. Speech pathologists know well the common mistakes made by toddlers based upon the difficulty of each phoneme. For instance, harder sounds involve more complicated movements within the mouth. They require more exact positioning of lips and tongue against the teeth and palate that may be difficult for a child to learn to do correctly and rapidly and include the sounds produced by c or k, g, f, s, sh. The hardest sounds for toddlers are v, th (in this, or three), zh (as in treasure and garage) ch, j, r, and consonants spoken together such as str, tr, dr, br, sq, st, sw. Incorporating these common errors into a “toddler language model” allows the system to function at a higher accuracy for recognition for beginning readers, and simultaneously allows the opportunity to teach the beginning reader correct pronunciation.

Connecting this special language model with the reduced active set of dictionary words further increases the accuracy of recognition away from misinterpreting an utterance as a completely correct word but not the word that is available to read. As with the above examples, “dump” is a valid word in English, but if the word on the page is “jump” the speech recognition system would clearly err in recognizing a correctly pronounced “dump” when it was not a word available to read. Similarly, consider the similar “two” vs. “shoe” example, amongst many other common errors resulting in the pronunciation of a different word than is meant for this population.

In certain embodiments this language model and active vocabulary combination could be used to recognize and score reading ability (in conjunction with a reading ability scoring algorithm, not disclosed herein) more accurately than other methods. As a reader is attempting to read words the system can recognize mispronunciations, erroneous word choices, and other indicators of reading ability more readily than systems which either do not monitor utterances, or those that monitor utterances but mis-attribute the utterance against the wrong word.

Applications

As will become evident in the examples below, numerous applications of this dynamic active vocabulary are envisioned. Notably, this technique is not device specific. While most of the descriptions of its use are on a computer, tablet computing device, smart phone, or dedicated electronic book reader, alternative approaches of application apply equally well as the technique is not specific to a type of device. For example, in certain embodiments the dynamic active vocabulary approach could be used via a chip embedded within a printed book and using a transparent page overlay display or similar hardware display device to provide highlighting within a more traditional book medium.

Similarly, this technique applies to highlighting the text for a single reader, but in certain embodiments it could apply equally well to paired devices where one person reads on one device while another person watches and listens from another device, either in the same room or on the other side of the world. By extension, this approach could be used to record a person, perhaps a professional voice actor, reading the book. Then at some later time another person may listen to the recorded audio book on their eReader with word highlighting matching the recording.

Finally, the highlighting could be simple marking or words or phonemes as previously described, but in certain embodiments could include animation or movie triggers upon completing the reading of specific words or sections of a book. In this manner an embodiment is envisioned where a graphic novel animates drawings as the reader reads the captions, or a movie unfolds as the reader reads the story.

The following examples are provided to illustrate the operation of the above described systems and methods. Where applicable, references are made to figures as described. Figure element indicators are used to indicate specific figure elements where numerics 1 xx refer to elements from FIG. 1, 2xx refer to elements from FIG. 2, and so on. Where the various examples are presented as an interconnected narrative, the interconnection is not necessary or expected as an aspect of the inventive subject matter. The embodiments may only provide functionality for any single example, or even a related topic obvious to one of ordinary skill in the art, and still provide an experience unique in the art. In the examples below, references to “eReader” refer to a system incorporating embodiments of the inventive subject matter.

FIG. 1

FIG. 1 is a block diagram of an example embodiment of a computer system 100 upon which embodiment's inventive subject matter can execute. The description of FIG. 1 is intended to provide a brief, general description of suitable computer hardware and a suitable computing environment in conjunction with which the embodiments may be implemented. In some embodiments, the embodiments are described in the general context of computer-executable instructions, such as program modules, being executed by a computer. Generally, program modules include routines, programs, objects, components, data structures, etc., that perform particular tasks or implement particular abstract data types.

The system as disclosed herein can be spread across many physical hosts. Therefore, many systems and sub-systems of FIG. 1 can be involved in implementing the inventive subject matter disclosed herein.

Moreover, those skilled in the art will appreciate that the embodiments may be practiced with other computer system configurations, including hand-held devices, multiprocessor systems, microprocessor-based or programmable consumer electronics, network PCs, minicomputers, mainframe computers, and the like. The embodiments may also be practiced in distributed computer environments where tasks are performed by I/O remote processing devices that are linked through a communications network. In a distributed computing environment, program modules may be located in both local and remote memory storage devices.

In the embodiment shown in FIG. 1, a hardware and operating environment is provided that is applicable to both servers and/or remote clients.

With reference to FIG. 1, an example embodiment extends to a machine in the example form of a computer system 100 within which instructions for causing the machine to perform any one or more of the methodologies discussed herein may be executed. In alternative example embodiments, the machine operates as a standalone device or may be connected (e.g., networked) to other machines In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 100 may include a processor 102 (e.g., a central processing unit (CPU), a graphics processing unit (GPU) or both), a main memory 106 and a static memory 110, which communicate with each other via a bus 116. The computer system 100 may further include a video display unit 118 (e.g., a liquid crystal display (LCD) or a cathode ray tube (CRT)). In example embodiments, the computer system 100 also includes one or more of an alpha-numeric input device 120 (e.g., a keyboard), a user interface (UI) navigation device or cursor control device 122 (e.g., a mouse, a touch screen), a disk drive unit 124, a signal generation device (e.g., a speaker), and a network interface device 112.

The disk drive unit 124 includes a machine-readable medium 126 on which is stored one or more sets of instructions 128 and data structures (e.g., software instructions) embodying or used by any one or more of the methodologies or functions described herein. The instructions 128 may also reside, completely or at least partially, within the main memory 108 or within the processor 104 during execution thereof by the computer system 100, the main memory 106 and the processor 102 also constituting machine-readable media.

While the machine-readable medium 126 is shown in an example embodiment to be a single medium, the term “machine-readable medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 128 may further be transmitted or received over a communications network 114 using a transmission medium via the network interface device 112 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, wireless data networks (e.g., WiFi and WiMax networks), as well as any proprietary electronic communications systems that might be used. The term “transmission medium” shall be taken to include any intangible medium that is capable of storing, encoding, or carrying instructions for execution by the machine, and includes digital or analog communications signals or other intangible medium to facilitate communication of such software.

The example computer system 100, in the preferred embodiment, includes operation of the entire system on a remote server with interactions occurring from individual connections over the network 114 to handle user input as an Internet application.

FIG. 2

FIG. 2 is a block diagram of the system 200 according to embodiments. In some embodiments, a file is loaded 202 and opened 204. Next, the embodiment enables the audible interactivity 206 by building active dictionary(ies) 208, building language model(s) 210, building highlighting list(s) 212, and enabling the audio input device 214. Flow then continues with accepting user input 216 to indicate the starting location within a document. Clearly this could default to the beginning of a document, but could also allow the selection of a point further into the document to begin reading. If input is received, then the scope of the active area is updated 220 to reflect this new starting location. Next the embodiment interprets any audio input 218 from any viable source, and proceeds to compare that input against the active dictionary(ies) in the context of the language model(s) 222. A successful comparison may then update the active dictionary scope 224 and subsequently allow the embodiment to highlight (in any of a variety of ways discussed elsewhere) 226 according to the recognized audio. Upon successful highlighting the highlighting scope is updated 228 and flow continues back with accepting new input (either actions or speech) 216 or completing the process and exiting 230.

FIG. 3

FIG. 3 is a block diagram of the active dictionary component 300 of the embodiments. In building an active dictionary 208, first a complete dictionary file must be built 302 to encompass the entirety of the document. Next, depending on the specific embodiment, zero or more active dictionaries must be built to reflect the different types of speech to recognize 304, corresponds also to 224. Included are active dictionaries to reflect different components within the text, such as chapter 306, page 308, paragraph 310, sentence 312, phrase 314, part of speech 316, phoneme 318, backward context 320, or other dictionary subset 322. Notably, when creating a phrase dictionary 314, the number of phrases included in the dictionary could vary by embodiment and include, e.g. a three word phrase window, a 5 word phrase window, or any other number of words to construct a phrase. Similarly, the phoneme dictionary 318 may vary in context size similar to the phrase dictionary. The backward context dictionary 320 may exist to allow general or specific focus on previously covered text to allow re-reading.

FIG. 4

FIG. 4 is a block diagram of the highlight list component 400 of the embodiments. In building a highlighting list 212, first a complete highlight list must be built 402 to encompass the entire text and track the current active location. Next, depending on the specific embodiment, zero or more highlight lists must be built to reflect the different locations where highlighting may occur 404, corresponding also to 228. Included are highlight lists to reflect different components within the text, such as chapter 406, page 408, paragraph 410, sentence 412, phrase 414, part of speech 416, phoneme 418, backward context 420, or other highlight list subset 422, including accessing or enabling an animation, movie, application programming interface (API) or the like 424. Notably, when creating a phrase highlight list 414, the number of phrases included in the highlight list could vary by embodiment and include, e.g. a three word phrase window, a 5 word phrase window, or any other number of words to construct a phrase. Similarly, the phoneme highlight list 418 may vary in context size similar to the phrase highlight list. The backward context highlight list 420 may exist to allow general or specific focus on previously covered text to allow re-reading. The accessing or enabling of a non-text element such as an animation or movie 424 could be used to play a movie or animation upon speaking the current text, or similarly do some other action according to the speech.

### EXAMPLE 1

### eReader

An electronic book reader is made available for use on an iPad via Apple iTunes. Nigel wants to work on his diction and pronunciation, so he begins using the eReader application on his iPad. Once he installs the eReader, from within the eReader he has the opportunity to purchase books to use with the eReader. Nigel chooses Moby Dick and begins reading. Since Nigel grew up in England, his accent is distinctly British and he chooses to use the American English pronunciation models to work on his American accent. As Nigel reads Moby Dick out loud, the eReader highlights the words and phonemes where he uses his British accent, allowing Nigel the external feedback he needed to practice his American accent.

### EXAMPLE 2

### Teaching Beginning Readers

Nigel recognizes the value of the eReader application for reinforcing reading and pronunciation skills. He chooses a children's book for teaching reading, “Dog and Cat” for his four year old daughter Emma. Nigel reads “Dog and Cat” to Emma with the eReader automatically highlighting the words that Nigel would normally have pointed to as he read. He then lets Emma try to read this book on her own. Since Emma is young, she mispronounces “cat” as “tat”. As she sounds out each word in “Dog and Cat” the eReader highlights the words as it did when her father, Nigel, read the story to her. However, in this case the eReader flags Emma's mispronunciations as she makes them. If she desires, she is able to select the flagged mispronounced word by tapping on the screen, and the eReader speaks the word with the correct pronunciation.

### EXAMPLE 3

### Teaching English as a Second Language

José is fluent in Spanish. However, he wants to learn English. Jose downloads the eReader application onto his iPad and finds an elementary reader book with both Spanish and English portions so he can read the English and then subsequently read the Spanish version of the same text. The eReader recognizes the dual language book and adapts to José's Spanish accent for English. As José reads the English words, the eReader highlights the words as he reads them, but also flags his mispronunciations as he makes them, allowing him to practice his English vocabulary and comprehension skills as well as his English pronunciations.

### EXAMPLE 4

### Working with Disabilities, e.g. Speech, Auditory, Visual, Learning, Autism, Brain Trauma

Jenn unfortunately had a brain tumor the size of a walnut. After surgical removal of the tumor, Jenn experienced certain speech problems, aphasias, and vision disruption on the left side of her visual field. Jenn discovered the eReader after discussions with her physical and occupational therapist about how she needed a way to work on her reading and speaking skills. Jenn began using the eReader for all her recreational reading and used the reader for a variety of books from science fiction and fantasy, to technical literature relevant to her work as a materials scientist, most of which were available directly via the eReader. Those titles that were not directly available in the eReader were available in PDF format and she was able to simply load those documents with her eReader. After using the eReader for several months, paying attention to the words that were highlighted as she spoke them, noticing when it flagged words she missed due to her visual impairment, and practicing the pronunciations the system flagged as she spoke, Jenn's collegues and loved ones noticed a marked improvement in Jenn's capabilities. Because of the value Jenn perceived from using this eReader, she recommended it to her friend Dan who had learning problems resulting from a car accident, her friend Willie who was mostly deaf and needed to practice his pronunciations when speaking, and her friend Angelique's son Will who has autism. In each case the eReader was able to focus the reader in on the specific problems of tracking their reading and pronunciation.

### EXAMPLE 5

### Teleprompter

Patrick has a hobby of producing videos where he describes the technical aspects of computer programming. Patrick likes to make sure the information he presents on camera is accurate, and also to help him with his camera fright, Patrick likes to script his speech and read it during the video. However, Patrick does not like the way he does not focus on the camera or activity he is describing since he tends to read off a printed sheet. Thus, Patrick discovers the eReader application for teleprompting. While some teleprompters move the text with the sound of speech, this eReader will actually match his speech to the next words in the script. This application allows Patrick to create his script in his text editor and then load it into the eReader. He then sets the eReader to scroll the text as he speaks, and, unlike in all other teleprompter systems, cross out all the words as he speaks them. Patrick then places the eReader between his camera and his computer screen and the resulting video appears more natural. In addition, Patrick's presentation of his script is more fluid since he no longer loses his place when reading and the eReader flags those words he misses as he reads, allowing him to quickly determine if he needs to do a re-take of the particular video segment.

### EXAMPLE 6

### Karaoke

Being an adept programmer, Patrick recognizes the opportunity to connect this teleprompter to his friend's karaoke machine. Patrick's friend Trent runs a business providing karaoke disk jockey services around town. Patrick connects the eReader's teleprompter functionality to the music-timed lyric track on Trent's machine. Now Trent's singers are able to see how their sung words match against the lyrics in time with the music, allowing them great feedback even when the bar crowds are too sparse or indifferent to provide that feedback.

### EXAMPLE 7

### Remote Reading

John likes to read to his twins every night. He perceives this as an important part of their learning and development, and makes sure that he points to the words as he reads them. He also thinks of this as an important bonding opportunity with his twins. Unfortunately, John's job requires him to travel regularly and spend several nights at a time on the road. So John links his eReader with that of the twins via the internet to set up a virtual environment, where he can read a book as the twins listen to John and see all the words in their book highlighted.

### EXAMPLE 8

### Recorded Audio Books

Ian is hired to read “the Hobbit” for an audio book by a company called AudioBoox. Ian uses the eReader to help him keep track of his position in the book as he reads, allowing him to make fewer reading errors. The eReader is acting as a teleprompter for Ian, marking off the words as he reads them. The recording of Ian reading “the Hobbit” is quite popular, and word spreads about how he used the eReader to produce the recording. His fans use the audio recording in conjunction with the eReader to watch each word highlight as Ian reads, making this a more entertaining and perhaps educational activity.

### EXAMPLE 9

### Graphically Enhanced Books

AudioBoox recognized the attraction of their customers to the eReader and decides to make a book that is more interactive. They start by creating a graphic novel that animates each cartoon cell as the reader speaks the words printed in the cell. They begin with a superhero graphic novel. Certain comic cells remain static and simply highlight the words as they are read out loud, while other cells use the completion of a spoken word as a trigger for animation. The first cell they animate shows the hero walking down a deserted street after the reader reads the final word in the line, “Out of the darkness, the Nightshade stalks through the city.” Then, as the reader goes to the next panel and reads, “POW!” a vibrant animation of the word “POW” resonates through the panel.

Readers find this interactive animation in the eReader quite compelling and AudioBoox makes a large profit. They turn part of this profit to connecting the “Harry Potter” movie series clips into the “Harry Potter” book series. When the book to movie integration is complete, each segment of the book is connected to a scene from the movie. In some cases the reader must complete reading the full book section before the related movie portion plays. In other cases the movie unfolds alongside the text as the reader reads, with the movie timing indexed to match the reader's reading speed.

### EXAMPLE 10

### Physical Book Overlays

AudioBoox sees many opportunities for the eReader application. The notice that a common movie merchandising play for children's movies and books is to attach a small electronic component to the book with buttons that play words or sounds in the voice of the movie character. Then, in the book there are visual indicators for when in the text the child should press the button to play the relevant sound. Knowing the possibilities of the eReader for providing an interactive experience, AudioBoox produces a print children's book with an electronic component in the book. They incorporate a sensor to identify the current page that is open for reading, a computer chip that has the book text electronically encoded, and a transparent physical page overlay with the capability of highlighting words on the page. Then, as the reader speaks the words on the page, the words are highlighted as AudioBoox noticed in their original use of the fully electronic eReader.

The examples provided above are not intended to be an exhaustive explanation of each possible operation of the systems and methods described herein, and the various embodiments are not limited to any example described above.

Although an overview of the inventive subject matter has been described with reference to specific example embodiments, various modifications and changes may be made to these embodiments without departing from the broader spirit and scope of inventive subject matter. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

1. The method of enhancing speech recognition and visual interactions; said method comprising:
using an electronic reader having a display of textual information corresponding to a document and the capacity to interact with a dictionary relating to said document in accordance with a user's utterances;
delivering aural utterances to said device;
and providing a visual indicator to said display corresponding to said delivered utterances to facilitate the user's understanding of said textual information.

2. The method as in claim 1 including the step of highlighting said visual indicator.

3. The method as in claim 2 including the step of matching said highlighted indicator to the active dictionary.

4. The method as in claim 3 including the step of tracking said aural utterances.

5. The method as in claim 4 including the step of triggering functional actions corresponding to said utterances wherein said triggering step could include one of movies, animation, and visual responses.

6. A non-transitory computer readable storage medium encoded with a plurality of instructions that, when executed by at least one processor on an electronic device in a distributed speech recognition system comprising an electronic device having an embedded speech recognizer and a network device having a remote speech recognizer remote from said electronic device, perform a method comprising:
using an electronic reader having a display of textual information corresponding to a document and the capacity to interact with a dictionary relating to said document in accordance with a user's utterances;
delivering aural utterances to said device; and
providing a visual indicator to said display corresponding to said delivered utterances to facilitate the user's understanding of said textual information.

7. The method as in claim 6 including the step of highlighting said visual indicator.

8. The method as in claim 7 including the step of matching said highlighted indicator to the active dictionary.

9. The method as in claim 8 including the step of tracking said aural utterances.

10. The method as in claim 9 including the step of triggering functional actions corresponding to said utterances wherein said triggering step could include one of movies, animation, and visual responses.

11. An electronic device for use in a speech recognition system comprising an electronic device, having:
at least one storage device configured to store information associated with aural utterances;
a speech organizer configured to recognize inputted aural utterances to produce a local speech recognition result;
at least one processor programmed to utilize said aural utterances received by the electronic device; and
a visual display having a visual indicator corresponding to said delivered utterances.

12. The method as in claim 11 including a means for highlighting said visual indicator.

13. The method as in claim 12 including a means for matching said highlighted indicator to the active dictionary.

14. The method as in claim 13 including a means for tracking said aural utterances.

15. The method as in claim 14 including a means for triggering functional actions corresponding to said utterances wherein said triggering step could include one of movies, animation, and visual responses.
